(19) United States
(12) Patent Application Publication
(10) Pub. No.: US 2021/0045564 A1
(43) Pub. Date: Feb. 18, 2021

(54) A PACKAGE RECEIVING AND RETURNING DEVICE

(71) Applicant: IDU GROUP LIMITED, The Bank Newtown (GB)

(72) Inventors: Kevin DUCKERS, Staffordshire (GB); Shaun FALCK, Devon (GB)

(73) Assignee: IDU DROP LIMITED, The Bank Newtown (GB)

(21) Appl. No.: 16/767,185

(22) PCT Filed: Dec. 3, 2018
(86) PCT No.: PCT/IB2018/059586

§ 371 Date: May 27, 2020

(30) Foreign Application Priority Data
Dec. 4, 2017 (GB) 1720150.0

(51) Int. Cl. A47G 29/14; A47G 29/20

(52) U.S. Cl. CPC A47G 29/141; B64C 39/024; A47G 29/20

(57) ABSTRACT

A package receiving and returning device for fitting to a sloping roof/building. The device has a storage cavity with an opening, a frame bounding the opening and a displaceable cover arranged in the frame which displaces from a closed first position wherein the opening is sealed thereby preventing access to the storage cavity, to an open second position which permits access to the storage cavity. A sensor detects presence of an unmanned aerial vehicle (UAV). A verification system verifies a designated UAV for a requested delivery or collection. An automated mechanism displaces the cover between the first and second positions when activated upon detection of the verified UAV to allow a payload to be delivered into, or retrieved from, the storage cavity. The automated mechanism positions the cover to define an entrance that corresponds to the features of the UAV and/or a payload to be received/returned, and/or environmental conditions.

### FIELD OF THE INVENTION

The present invention relates to a package receiving and returning device and related system. More particularly the invention relates to a device for automatically receiving and sending packages to/from a specified address. In a preferred embodiment a device is used for receiving and returning packages to/from an unmanned autonomous vehicle (UAV) which is sometimes referred to as a drone.

### BACKGROUND

Increasing reliance on automation is a feature in many societies. Vehicles are becoming automated, driverless or unmanned. Such vehicles may be small and pilotless, arranged to hover or similar, and colloquially known as drones.

Such drones are used to deliver small and large packages to delivery addresses, which may be domestic or commercial. In order to facilitate such deliveries the premises accepting the delivery ideally needs to be able to accept a delivery at any time of day, safely, and securely and with minimal interference to the premises and its occupant.

### PRIOR ART

US 2017 0 116 568 (PLEIS) discloses a delivery receptacle, comprising: a housing having a base, upstanding sidewalls, and an open upper end, defining an interior volume; one or more gates covering the open upper end and movable between an open configuration and a closed configuration via an actuator. A control circuit comprises a detection mechanism and a means to actuate the actuator, wherein the actuator moves the one or more gates from the closed configuration to the open configuration when the detection mechanism detects a delivery vehicle.

CN 105 484 607 (LIN et al) discloses a method based on smart windows for unmanned parcel delivery system includes a user terminal, smart windows, and an unmanned aircraft parcel delivery service control terminal, wherein the user operates the control terminal communications connection end with a carrier, and the courier service control terminal is connected to an unmanned aerial vehicle control. The window is provided with at least one sensing means and drive mechanism for opening and closing, cooperating with an unmanned aerial vehicle provided with a second sensing module.

WO 2015 103 411 (WALSH et al) discloses a landing pad that receives, and stores packages delivered from an aerial vehicle. The landing pad can be placed outside a window and can contain a transmitter for sending out an identification signal via radio frequency to aid aerial vehicles in finding the landing pad. The landing pad contains a landing platform with a trapdoor that leads to a storage compartment. The trapdoor can be configured to only open when it receives a signal from an authorized aerial vehicle. The storage compartment can be accessed via a storage compartment door which can contain a locking mechanism. The storage compartment can be climate controlled. The landing pad can also have a transmitter that emits sounds to discourage animals from nesting on or near the landing pad. The landing pad may also include a solar power generator as a source of electrical energy.

US2017/0228692 (Pargoe) discloses an Airbox to receive deliveries from a drone.

GB2544657 (Clark et. al.) discloses a securable container for deliveries.

WO2016/163779 (lee et. al) discloses a drone delivery receiving box.

US2017/0116568 (Pleis) discloses a drone operated delivery receptacle for receiving packages.

The present invention arose in order to overcome problems encountered by existing devices.

### SUMMARY OF THE INVENTION

According to a first aspect of the present invention there is provided a package receiving and returning device for fitting to a part of a sloping roof/building comprising: a storage cavity with an opening, a frame bounding the opening and a displaceable cover arranged in the frame which displaces from a first closed position, wherein the opening is sealed thereby preventing unauthorised access to the storage cavity, to a second open position which permits access to the storage cavity; at least one sensor detects presence of an unmanned aerial vehicle (UAV); a verification system is operable to verify a designated UAV for a requested delivery or return; and an automated mechanism displaces the cover between the first and second positions when activated upon detection of a verified UAV to allow a payload to be delivered into, or retrieved from, the storage cavity, wherein the automated mechanism operates a positioning means to position the cover to define an entrance that corresponds to the features of the UAV and/or a payload to be received/returned, and/or environmental conditions.

Ideally the at least one sensor includes or comprises a proximity detector that is operable to identify the presence of the UAV. The sensor may also be adapted to request an authentication code and/or an identification signal from the UAV.

In this way the device provides a safe delivery and collective system which permits secure delivery of items which can include whilst a homeowner is not at home. As the device enables secure aerial delivery the items are not subjected to usual traffic delays, therefore providing improved accuracy and speed of delivery and collection times.

Preferably the storage cavity has a water drainage tray that permits drainage of rainwater. This allows any water collected on the delivered item to drain away to the tray rather than leaving the package sitting in liquid.

Preferably the cover is arranged to displace to the second position in a particular way so as to provide a larger potential footprint or opening. For example the cover may fold outwards so as to not interfere with the cavity space. In some embodiments the cover may fold outwards and downwards (or upwards) to provide a platform that can be used to help guide the UAV to the cavity.

Typically the cover is multipartite being formed from two or more joined parts or pieces which are connected one to another by way of a weather proof seal. The parts may be arranged to move with reference to each other and/or the frame, for example to fold, concertina or roll to open and close the opening.

The cover is associated with the automated movement mechanism to automate opening and closing. The movement mechanism is configured to operate with the positioning means to alter the size or shape of the opening in order to best receive the UAV and payload. It is appreciated that the payload may be dispensed or collected in such a way that only the payload passes through the entrance with the UAV hovering above the entrance. For example the payload may be lowered/retrieved by an elongate member such as a line.

The positioning of the cover to be achieved by the positioning means may be determined by detection or receipt of information of various factors such as features of the UAV to include size, weight, downdraught, or manoeuvring capability; data relating to the item (payload) such as size, shape or weight; and/or environment details such as detection of rain or wind direction. The information may be used to open the cover in a particular way or orientation.

The movement mechanism is configured to operate with the positioning means to adjust the cover position to correspond to features of the UAV and/or features of a payload (item) and/or features UAV and payload being delivered/collected. In this way the size and shape of the opening is adjusted to reflect the delivery or collection.

The movement mechanism is also configured to operate with the positioning means to adjust the cover position in response to environmental conditions. In this way the cover is configured to either provide protection of the UAV and/or payload at the entrance, for example by providing shelter, and/or to protect the storage cavity, for example to provide a barrier to deflect or direct wind or rain away from the cavity.

In this way the cover may be configured to open in different ways depending on the UAV and/or payload. For example the cover may fold to provide a barrier that deflects the wind and so reduces buffeting to the UAV and payload by the wind.

It is appreciated that this may mean that the opening may be partially open depending on the package to be received or collected and taking into account the environmental conditions. In this way the opening is sized to enable the safest access for the UAV, payload or UAV and payload.

To achieve selective configurations of the covers, the, or each, cover panel may be configured to define different shape and size of openings and/or to provide shelter from different conditions.

A manual mechanism may be provided to permit opening or closing of the device in the event of a technical or electrical failure. Preferably the manual mechanism comprises an internal fitting accessible from within the premises such as a screw type mechanism that is connected to a main drive of the system in order to allow for manual opening or closing of the opening if required.

The movement mechanism may comprise a folding mechanism, for example arranged to gradually fold and unfold at least two jointed cover panels. The positioning means operates with the movement means to selectively control the range of movement of the folding panels so that the opening created for the UAV is variable.

The movement mechanism may comprise a worm-screw or similar variable length arm to permit selective folding of the cover panels depending on how far the worm-screw is turned.

The displacement of the cover may enable maximisation of the opening, such that the panels open to below or the sides of the frame, providing a splayed opening.

The device has at least one sensor to detect presence of UAV. Preferably the sensor operates wirelessly to detect approach or exit of the UAV.

The sensor may comprise a transceiver arranged to transmit and receive signals. In this way the transceiver can be used to interrogate a drone when it is within range. Optionally a presence detector, such as a RADAR or LIDAR device may be deployed to scan for UAVs entering within range of the transceiver. These steps enable the UAV to be identified prior to access to the cavity is permitted.

The system is ideally configured such that when an order is placed, and payment is completed or a delivery of an item is requested, an UAV is dispatched from a central depot. The order or collection request verifies that a designated UAV can be dispatched to a delivery address specified by the user. Therefore separate delivery verification is not necessarily required at the delivery (collection) address if verification is already confirmed as part of the order (or collection request) and the UAV or the ordering (booking) system has prior knowledge that a package receiving and returning device fitted at the delivery (collection) address.

The verification system serves to verify an UAV for a specified address or number of addresses. The UAV may be assigned to a delivery or collection at the point at which an order is placed or a return is requested. From this point the UAV is verified for the specified address or addresses.

It is appreciated that in some embodiments verification of the UAV may be completed after the delivery or collection transaction, for example with a particular time slot which may be selected during the transaction (so that a UAV is not assigned until close to the dispatch time), or on arrival at the device.

In this way, once an order or collection request is made through a platform, such as an e-commerce site, verification steps are triggered, scheduled, or become initiated by a separate step, to ensure that an authorised UAV arrives at the correct delivery address where arrival of the UAV is expected by the package receiving and returning device.

The verification system may also include a means for analysing data and a means to compare data with stored data on a database in order to ensure the UAV detected at the device corresponds to the UAV deployed and authorised for a particular delivery or collection. These additional steps may be used to provide a further security check that the UAV has been dispatched to and/or arrived at the correct address.

The data may be obtained from the UAV or alternatively may be received from a remote source, such as signal initiated by a user's acceptance of a delivery or collection or from a third party or as part of a block-chain authentication process.

In some embodiments a verification system or means may be configured to send a message to a mobile communication device, such as a smartphone, to alert a user of an imminent or actual delivery or collection event. This may be useful for unexpected deliveries, or where an item is of high value and the delivery or collection of the item requires acceptance, in a similar manner to a ‘Special Delivery’ or ‘Recorded Delivery’ made through the postal service.

The verification system may also be configured to receive an acceptance message from a mobile communication device to acknowledge that a delivery is accepted or collection has been made.

The messages may be sent via Bluetooth® or through another similar wireless network, means such as a mobile telephone network or via the Internet.

For example, detection of the UAV at the device, logging of its GPS location or detecting its arrival at a predefined location may be performed automatically. Optionally geo-locating data of the UAV at a region may be provided in a geocoding system (such as What3Words®) that corresponds to the delivery/collection address. Such geocoding data may trigger a signal to be sent to a user who is expecting the delivery in order for them to accept the delivery. Once an acceptance signal is issued by the user, for example by accepting the delivery by means of a smartphone app, a verification signal is logged on the system and delivery is deemed completed and the automated opening is closed.

In some embodiments the verification or detection of a verified UAV may be carried out by means of an electronic handshake which ensures the identified UAV corresponds to the UAV deployed to that address, and/or that the user's acceptance has been received. Additionally a signal can be transmitted from the UAV to a remote or local receiver indicating that a delivery (collection) has been made and the UAV is ready for its return flight and unimpeded by the cover that defines the entrance to the device.

In some embodiments the verification system and means for detecting the verified UAV may use data or permissions derived from a block-chain system.

The verification system and means for detecting the verified UAV may also incorporate a time stamp function to ensure delivery or collection is only allowed within an allotted delivery time.

The device may include a controller to manage operation of the device. The controller may coordinate opening and closing in response to signals detected and activate the transceiver, where for example the transceiver remains in a dormant or standby mode until activated.

The device may optionally include a sensor in the form of a scanner. Preferably the one or more sensors are contained in an electronics casing such as a field programmable gate array (FPGA) or similar module, to permit user programming.

The casing may be located on the outside of the frame so that UAV can be readily detected. In some embodiments the casing may be integrated with the frame.

The cover may be transparent or translucent or include a transparent or translucent panel to define or include a window. For example the cover may include or comprise a window or skylight. The cover may comprise two or more panels which may be transparent or translucent or may include transparent or translucent portions, arranged to fold so as to displace into the second position.

The cavity is typically configured to extend rearwards of the cover, so as to provide a confined space for receipt of UAV deliveries or items to be collected. The storage cavity may include a shelf.

The cavity may be a sealed or may include a sealable compartment.

The cavity preferably has a drain tray to ensure liquid in the cavity is drained, such as rain collected on the item. Such a drain may comprise an egress to an exterior location or may alternatively (or additionally) comprise a displaceable collecting tray or part.

There may also be a drainage emergency overflow to prevent flooding or overflow where there is a failure to close the opening, such as due to a technical or mechanical failure. The emergency overflow allows excess water to be collected rather than to overflow within the roof space. For example an overflow route from the drain tray may permit escape of water when it reaches a particular level, channelling water along a pipe to a storage container.

In some embodiments the device may include a vent to prevent build-up of moisture or condensation.

In some embodiments the cavity may comprise doors or other displaceable boundaries, so as to allow user access to its interior.

In some embodiments the device may comprise a beacon or signalling means to alert the UAV to its exact location, thereby assisting the UAV to home in to its location.

In some embodiments this signalling means may comprise an active signalling means, for example comprising a broadcasting means. In other embodiments this signalling means may comprise a passive signalling means, for example comprising a signal, QR code or other machine-readable code which may be readable when the UAV is within close range of the device.

In some embodiments the device may comprise weather sensors and/or may be connected to a weather warning system, which may allow for the device to recognise adverse weather conditions and alter variables of the delivery remotely, for example rescheduling the delivery where appropriate.

Additionally the device may include a heating element to ensure the device is operational in cold and icy conditions. In some embodiments the displaceable cover may have an integrated heating element, similar to those provide in vehicle windows to ensure the cover is kept clear or snow and ice.

In some embodiments the frame may comprise effective opening enlargement means, for example wings or baffles. The baffles preferably have a shark fin configuration which define projections from the opening which shelter the mechanism and further define the entrance to the opening.

For example in some embodiments the device may comprise baffles to sides and/or top, which may be displaced by the mechanism or may be permanently positioned. In some embodiments baffles around the opening may comprise elastic mounting or composition, for example so as to resist or rebound misplaced deliveries.

In some embodiments the device, in particular the entrance and storage cavity, may comprise resiliently deformable or flexible material. This may enable packages to be delivered, held and released without damage.

For example in some embodiments the device may include a ribbed net with a flexible base fitted to its inside, to catch and stop the parcel being dropped onto a hard surface and becoming damaged after delivery. Such net may also enable parcels to be kept dry by maintaining the package above a wet surface. Ribs may be attached horizontally to shape the internal net to the receiver like a fishing keep net.

Some such embodiments may comprise draw cords to pull the net base up and down to the required height for example so that a package can be picked up by an UAV for unwanted deliveries. Such cords may be operable by the drone or local user, to facilitate pickup/return.

The device operates as part of a delivery and collection system. The system for delivery includes the steps of:
1. Making an order for an item to be delivered to a specified address.
2. Generating a delivery time.
3. Verifying an UAV to deliver the item (payload).
4. Deploying an UAV with the item (payload) to a specified address.
5. The device detects arrival of the verified UAV device and activates the movement mechanism and positioning mechanism to open the cover(s).
6. The item is delivered through the opening.
7. Exit of the UAV is detected to activate closing of the cover(s).

The system for collection includes the steps of:
1. Making a request for an item to be collected to a specified address.
2. Generating a collection time.
3. Verifying an UAV to collect the item (payload).
4. Deploying an UAV to a specified address.
5. The device detects arrival of the verified UAV and activates the movement mechanism and positioning mechanism to open the cover(s).
6. The item is collected through the opening.
7. Exit of the UAV is detected to activate closing of the cover(s).

Preferably the delivery or order is authorised at the point of order or requesting a collection. This step verifies an UAV to perform the delivery/collection. Therefore there is no requirement for a user to approve delivery or collection on arrival at the device, thus providing a more efficient delivery and collection process. This system also avoids the chance of interruptions to a delivery or a collection if an updated instruction is received during the delivery or collection phase, or if a user was unable to use their smartphone, for example due to being in a meeting, or having no battery remaining.

It is appreciated that a user may register their device with a delivery/collection provider, such as an e-commerce platform. Once the device is registered orders and collections made through the platform are considered as authorised with regards to acceptance of an UAV, once the order or collection transaction is completed.

The device may communicate with a mobile device, such as a smartphone, to advise of status of the device, for example if the device is full, contains one or more delivery, the opening mechanism is jammed or faulty or requirement maintenance. To do this the device may generate signals to be sent to a remote device, such as a smartphone, in order to provide a user with a status message. Such signals may be sent over a network, such as a mobile phone network, or IoT network.

It is appreciated that there may be an option to communicate with the device and/or UAV when handling unexpected deliveries or collections. For example if a friend were to order a surprise gift a signal may be sent to a user asking if they are willing to accept the delivery. In this situation a user may receive a message asking for the delivery to be accepted.

Preferred embodiments of the invention will now be described by way of example only and with reference to the Figures in which:

### BRIEF DESCRIPTION OF FIGURES

FIG. 1 shows an isometric view of a frame and displaceable cover of a device according to the first aspect of the present invention, in a first closed position;

FIG. 2 shows a reverse isometric view of the frame and displaceable cover shown in FIG. 1;

FIG. 3 shows an isometric view of a device according to the present invention comprising the frame and displaceable cover shown in FIG. 1 fitted to a sloped surface in a second open position;

FIG. 4 shows a reverse isometric view of the device shown in FIG. 3;

FIG. 5 shows an isometric view of the frame and displaceable cover shown in FIG. 1 in an intermediate position between the first and second positions;

FIG. 6 shows a reverse isometric view of the frame and cover shown in FIG. 1 in an intermediate position between the first and second positions;

FIGS. 7a and 7b show isometric views of ends a screw mechanism comprised by the frame and cover shown in FIG. 1;

FIG. 8 shows an exploded isometric view of the screw mechanism shown in FIG. 7;

FIG. 9 shows an exploded isometric view of the frame and cover shown in FIG. 1;

FIG. 10 shows a reverse exploded isometric view of the frame and cover shown in FIG. 1;

FIG. 11 shows a reverse exploded isometric view of the screw mechanism embodiment shown in FIG. 7;

FIG. 12 shows profile views of the displaceable cover shown in FIG. 1 in the first closed position, the second open position and an intermediate position; and

FIG. 13 shows an example of a system of operation including a device according to the first aspect of the present invention.

### DETAILED DESCRIPTION OF FIGURES

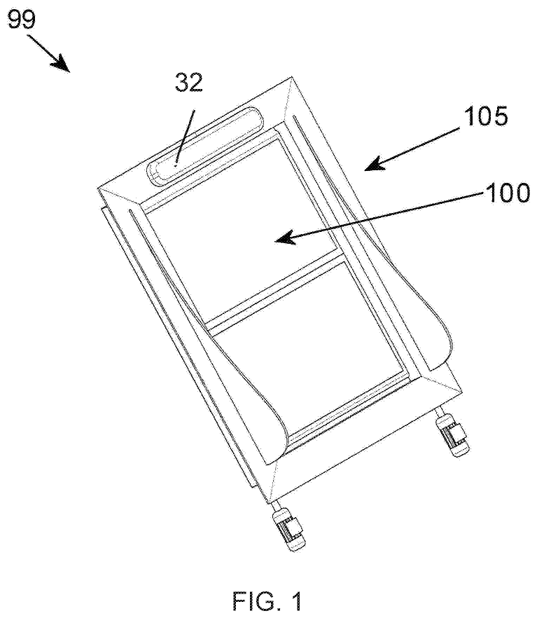

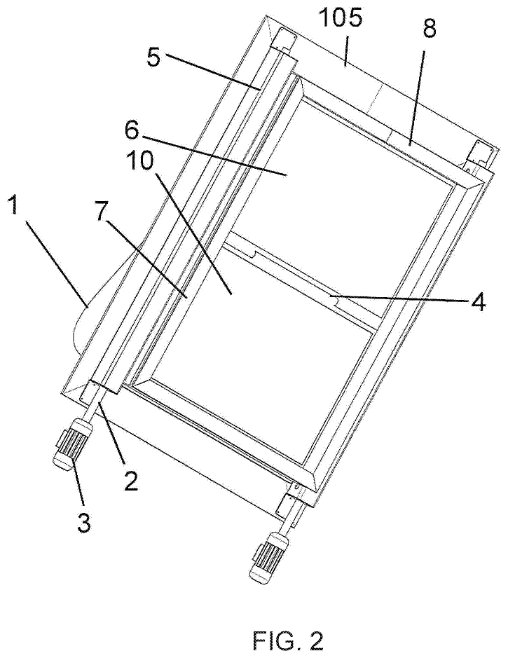

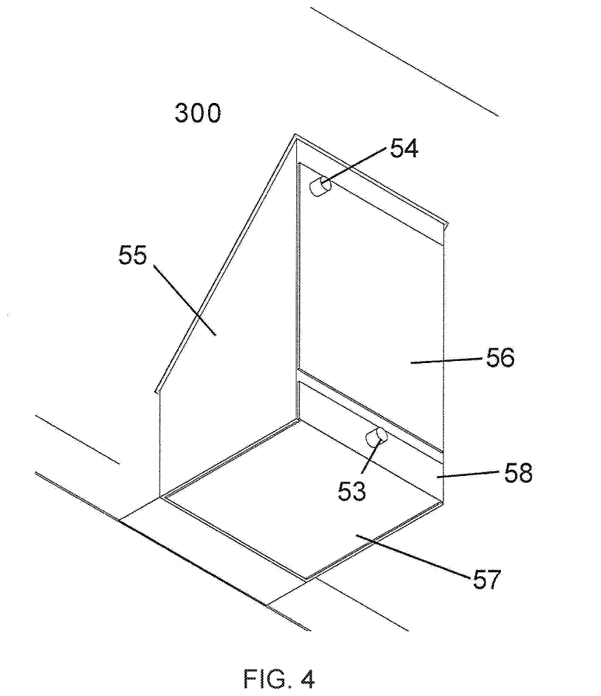

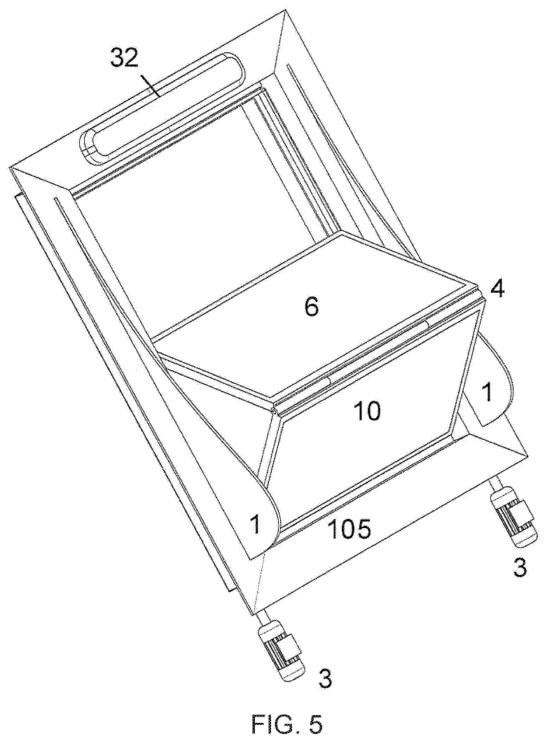

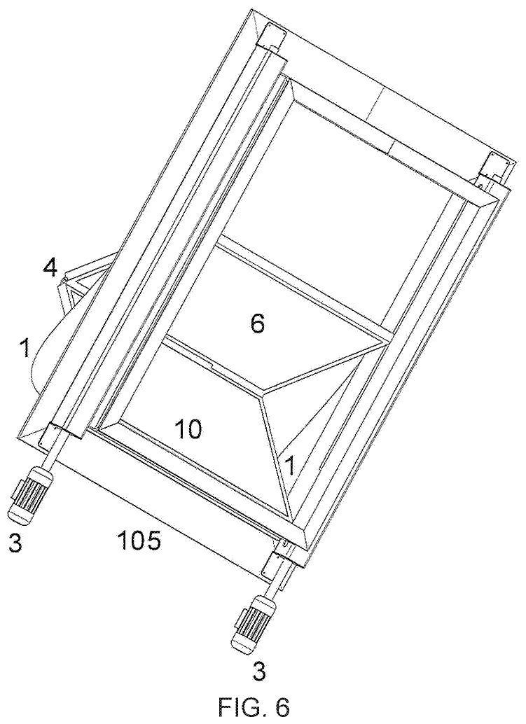

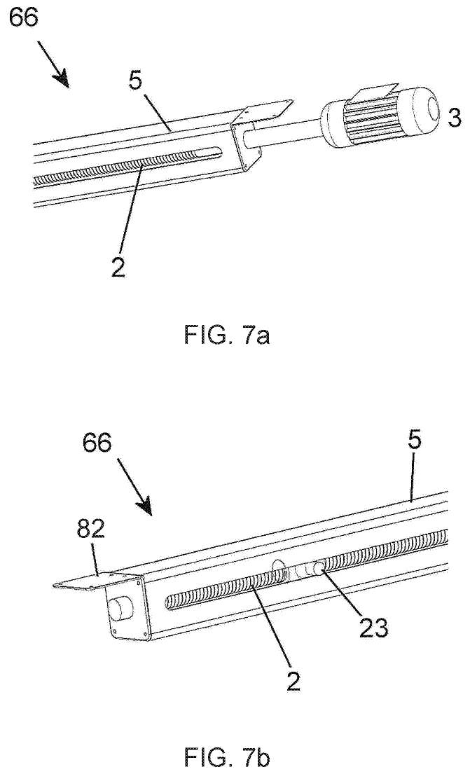

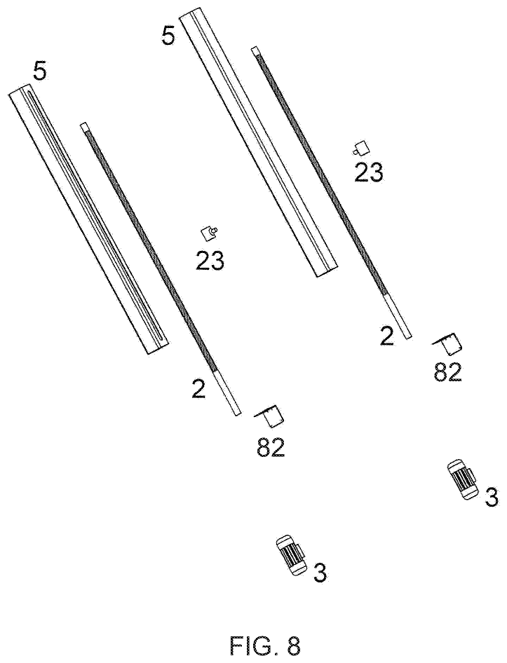

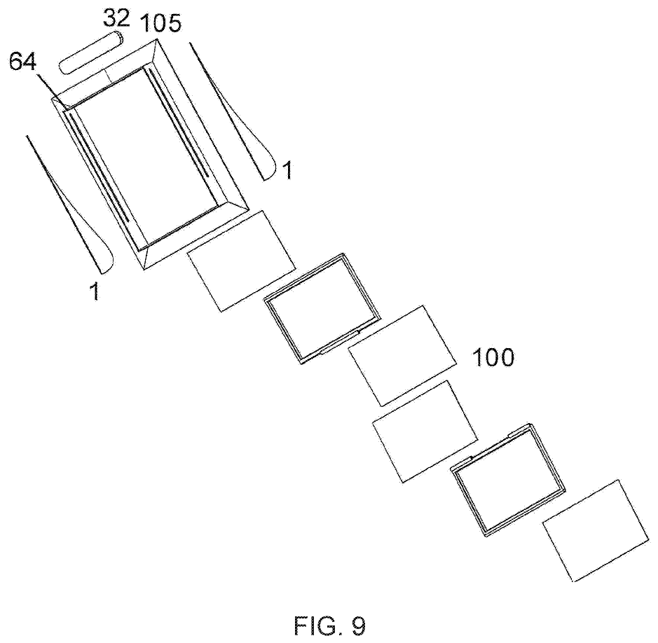

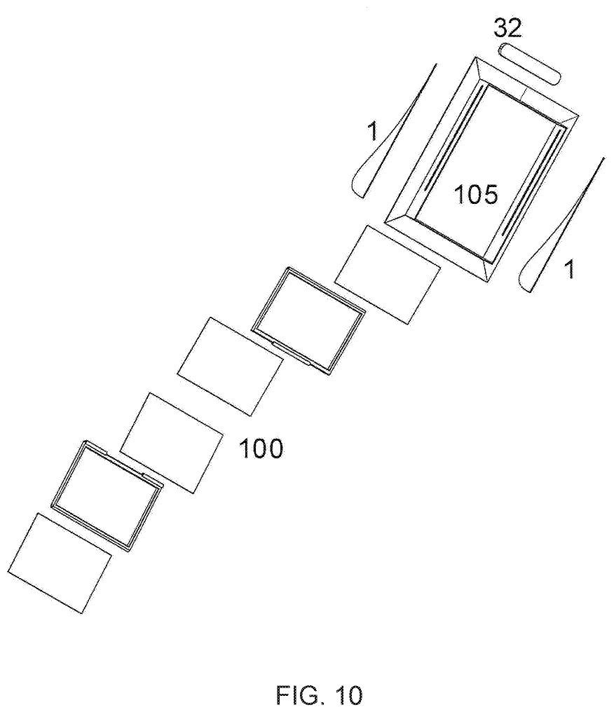

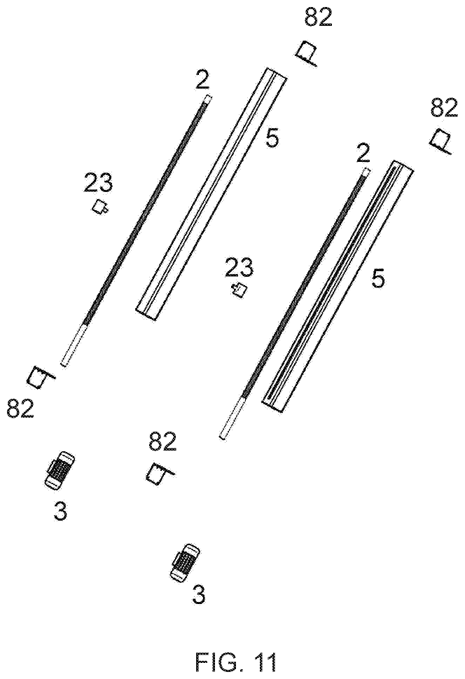

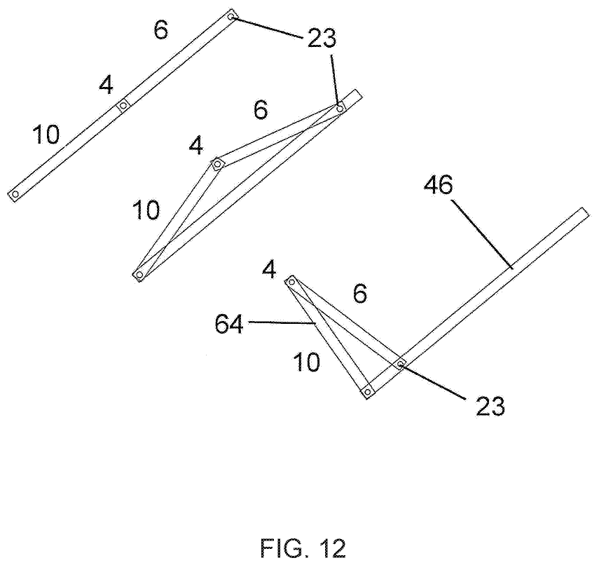

FIGS. 1 to 12 show a package receiving device 99 according to the first aspect of the present invention and components thereof. The device 99 comprises a compartment 200, a frame 105 surrounding an opening into the compartment 200, and a displaceable cover 100 which is arrangeable to close the opening.

The displaceable cover 100 is in the form of a bipartite window 100 arranged within the frame. The cover 100 is displaceable between at least a first closed position or arrangement in which it closes, blocks and seals the opening into the compartment 200 bounded by the frame 105 and a second open position or arrangement in which the opening into the compartment 200 bounded by the frame 105 is open, thereby enabling receipt or collection of a package or other object through the opening. The cover is displaced between the first and second positions by an automated mechanism responding to detection of an UAV.

The device 99 is for installation in a sloped structure such as a building roof 300. The device being arranged such that the frame 105 and the opening of the compartment 200 are generally parallel to and flush with the surface of the structure or roof 300.

In the illustrated embodiment, the frame 105 and the displaceable cover 100 (which are shown in detail in FIGS. 1, 2, 5 and 6) are in the form of a skylight. The illustrated cover 100 comprises two rectangular glass panels 6, 10 connected together by a hinge 4 which extends along a long edge of each panel 6, 10. The illustrated frame 105 is rectangular and is formed from a thermoplastic material.

It will be appreciated that the cover and/or frame may be of a different structure or formed from other suitable materials without departing from the scope of the invention as defined by the claims. The cover may be partially or substantially transparent, translucent or opaque, and may be formed from three or more interconnected panels.

The structure 300 in which the device 99 is installed is envisaged to be a roof of a building or premises, for example a domestic or commercial property. The cover may comprise or be formed from a hard composite plastic that matches the roof style and type, or may comprise or be formed from any of the following without limitation: glass, composite plastic and/or photovoltaic cells, depending on whether or not the user wants to use the device to be arranged as a window or skylight, and/or whether the user wishes the device to match the surface of the roof.

The frame 105 comprises and supports a mechanism 66 for displacing the cover 100 between its first open position and its second closed position. The mechanism 66 is arranged to fold the two panels 6, 10 of the illustrated cover together about their mutual hinge 4 so as to open the opening to the cavity 200 of the device 99 for delivery purposes (by displacing the cover 100 into the second position).

The mechanism 66 comprises two leadscrews 2 and a pair of motors 3. Each leadscrew extends along one long side of the rectangular frame 105. Each leadscrew comprises an elongate housing 5, a screw 2 and a nut 23 which is displaced along the screw 2 as the screw 2 is rotated. Each leadscrew is mounted on the inside (downward facing) surface of the frame 105 by a pair of L-shaped brackets 82 and is driven by one of the motors 3. The motors 3 may be permanently wired into the electrical system of the building in whose roof the device is installed.

The two nuts 23 comprise elements which project from the screws 2 through slots 46 in the housings 45 and in side wall 64 of the frame 105 which surround and are at right angles to the opening of the compartment 200 such that they project into the opening where they are connected to upper corners of the upper panel 6 of the displaceable cover 100. As the screws 2 are rotated by the motors 3, the screws are displaced along the length of the screws 2 within the housings 5.

The two leadscrews 2 are mirror images of each other and in use are driven at the same rate by the motors 3, such that the two nuts 23 remain level with each other in use.

The lower edge of the lower panel 10 of the pair of panels 6, 10 comprised by the displaceable cover is connected to the lower short edge of the frame 105 by a hinge mechanism and the upper edge of the lower panel 10 is connected to the lower edge of the upper panel 6 by a hinge 4.

Therefore, as the nuts 23 are displaced along the screws 2, channels 5 and slots 46, the upper edge of the upper panel 6 will be displaced across the opening of the compartment 200, thereby causing the distance between the upper edge of the upper panel 6 and the lower edge of the lower panel 10 to vary and the two panels 4, 6 to fold together and apart.

When the nuts 23 are displaced to the upper ends of the screws 2, channels 5 and slots 46, the upper and lower panels 6, 10 will be parallel to each other and flush with frame 105 and the opening of the compartment 200, such that the cover 100 is in its first closed position and the opening of the compartment 200 is closed.

As the nuts are displaced own the screws 2, channels 5 and slots 46, the two panels 4, 6 will fold with respect to each other and outwards with respect to the frame 105 and the opening of the compartment 200. The second open position is an arrangement where the panels 6, 10 are folded at least partially together such that an opening is provided between the upper edge of the upper panel 6 and the upper edge of the frame 105.

In some embodiments, the second position may be an arrangement wherein the nuts 23 and the upper edge of the upper panel 6 have been displaced most or substantially all of the way from the upper edge of the frame 105 towards the bottom edge of the frame 105 such that the opening of the compartment is mostly or substantially uncovered. In alternative embodiments, in the second position the nuts 23 and the upper edge of the upper panel 6 have been displaced half or less than half of the way from the upper edge of the frame 105 towards the bottom edge of the frame 105 such that the opening of the compartment is only half or less than half uncovered.

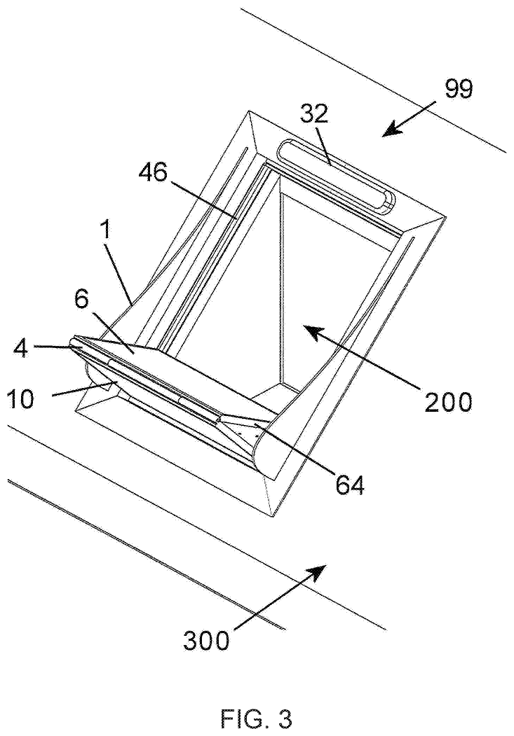

In open or partially open arrangements, the panels 6, 10 fold outwards from the frame 105 away from the compartment 200. Therefore the upper panel 6 may be arranged to act as a scoop or chute which may guide a package into the compartment (for example, as shown in FIG. 3) by forming a slope angled in the opposing direction from the surface 300 in which the device 99 is installed.

The illustrated frame 105 comprises four side walls 64 which are arranged at right angles to the opening of the compartment 200 and to the surface of the structure 300 in which the device 99 is installed. The side walls 64 are arranged to define a rectangular aperture which defines the opening into the compartment 200. The two side walls which extend at an angle up surface of the structure 300 (between the two side walls which extend generally horizontally) comprise elongate slots 46 extending along their length through which the nuts 23 of the leadscrews protrude. The frame 105 further comprises a flange extending outwards from the upper edges of the side walls substantially parallel to the opening of the compartment 200 and the surface of the structure 300. The flange is at right angles to the side walls 64 and acts to prevent any gaps between the opening of the compartment 200 and the surface of the structure 300. An electronics module 32 is supported on the exterior upwards facing surface of the flange above the upper edge of the opening of the compartment 200. The leadscrews 2 are supported on the downwards facing underside of the flange by brackets 82 adjacent the sloped side walls 64 of the frame 105.

The device 99 comprises a compartment 200 to whose opening the frame 105 is fitted; the frame being located underneath the opening surrounded by the frame 105. The compartment comprises a generally square horizontal base 57, two side walls 55 with sloped upper edges which meat the sides of the frame 105, and a substantially vertical rear wall arranged opposite the frame 105 and extending between the base 57 and the upper edge of the frame 105.

The rear wall comprises a door 56, with a side hinge and a handle 54. The base 57 and a portion of the rear wall define a tray 58 which is arranged for receipt of rainwater, in the form of a displaceable drip tray 58. The tray comprises a handle 53.

The frame 105 comprises two side wing baffles 1, which extend outwards from flange portion of the frame adjacent the sloping edges of the opening of the compartment 200. The baffles 1 extend substantially perpendicularly to the surface of the structure 300 in which the device is installed. The baffles 1 enlarging progressively as they extend from the upper edge towards the bottom edge of the frame 105.

These baffles 1 may help guide a delivery package into the compartment 200, in cooperation with the upper folded panel 6 of the cover 100 by providing side boundaries of a defined area, slide or chute for delivering a package into. In this way the package may be prevented from being blown to either side of the delivery area, as well as to below.

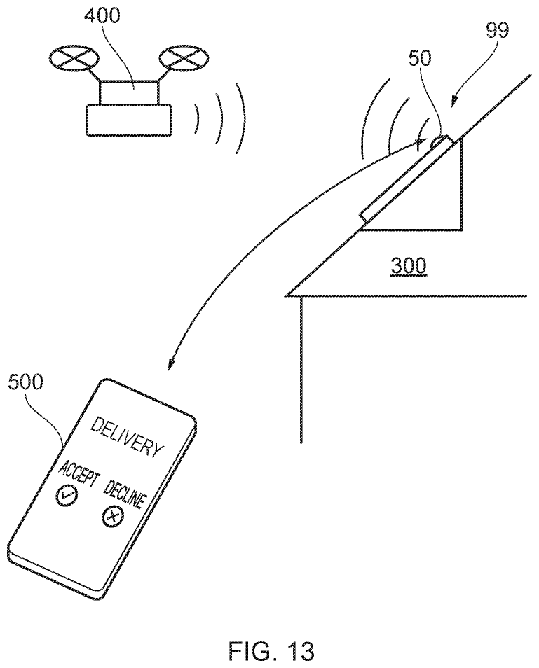

FIG. 13 discloses a system of operation including the package receiving and returning device 99. This system is intended for use when unknown or unexpected deliveries or collection requests are detected.

The device 99 is fitted to a roof 300. A sensor 70 detects present of an UAV. Upon detection of the UAV 400 the verification system is activated so that the UAV 400 can be identified and verified. The verification process includes transmission of a signal from the sensor 70 to a remote electronic device 500 to advise a user that an UAV 400 has arrived.

A user is then prompted to either accept or decline the delivery or collection. If the delivery/collection is accepted an acknowledgment signal is returned to the device to permit opening of the cover to receive the UAV. If the delivery/collection is declined a signal is sent to the device and onto the UAV to advise of decline acceptance.

The invention has been described by way of examples only and it will be appreciated that variation may be made to the above-mentioned embodiments without departing from the scope of invention as defined by the claims.

1. A package receiving and returning device for fitting to a part of a sloping roof/building comprising:
a storage cavity with an opening;
a frame bounding the opening and
a displaceable cover arranged in the frame which displaces from a closed first position, wherein
the opening is sealed, thereby preventing unauthorized access to the storage cavity, to an open second position which permits access to the storage cavity;
at least one sensor detects presence of an unmanned aerial vehicle (UAV);
a verification system is operable to verify a designated UAV for a requested delivery or return; and
an automated mechanism displaces the cover between the first and second positions when activated upon detection of the verified UAV to allow a payload to be delivered into, or retrieved from, the storage cavity, wherein
the automated mechanism operates a positioning means to position the cover to define an entrance that corresponds to the features of the UAV and/or a payload to be received/returned, and/or environmental conditions.

2. The package receiving and returning device according to claim 1 wherein the storage cavity includes a water drainage tray to permit drainage of rainwater.

3. The package receiving and returning device according to claim 1 wherein the cover comprises a window.

4. The package receiving and returning device according to claim 1 wherein the cover comprises hard composite plastic that matches a style and type of a roof.

5. The package receiving and returning device according to claim 1 wherein the cover includes one or more photovoltaic cells.

6. The package receiving and returning device according to claim 1 wherein the cover comprises two or more cover panels.

7. The package receiving and returning device according to claim 6 wherein the two or more cover panels bi-fold to open.

8. The package receiving and returning device according to claim 1 wherein the cover folds substantially downwards on the frame into the open second position.

9. The package receiving and returning device according to claim 1 wherein the positioning means includes a worm screw positioning mechanism.

10. The package receiving device according to claim 1 comprising an enclosed receiving compartment with a displaceable drip tray.

11. The package receiving device according to claim 1 comprising a weather sensing means.

12. The package receiving device according to claim 1 wherein the frame comprises side baffles.

13. The package receiving device according to claim 1 wherein the open second open position enlarges an effective footprint of a footprint.

14. The package receiving device according to claim 1 comprising a net structure for package receiving or returning.

15. The package receiving device according to claim 1 wherein the verification system is configured to send a message to a mobile communication device to alert a user of a delivery or collection.

16. The package receiving device according to claim 1 wherein the verification system is configured to receive an acceptance message from a mobile communication device to acknowledge that a delivery or collection is accepted.
